(19) United States
(12) Patent Application Publication
(10) Pub. No.: US 2011/0307661 A1
(43) Pub. Date: Dec. 15, 2011

(54) MULTI-PROCESSOR CHIP WITH SHARED FPGA EXECUTION UNIT AND A DESIGN STRUCTURE THEREOF

(75) Inventors: Jack R. SMITH, South Burlington, VT (US); Sebastian T. VENTRONE, South Burlington, VT (US)

(73) Assignee: INTERNATIONAL BUSINESS MACHINES CORPORATION, Essex Junction, VT (US)

(21) Appl. No.: 12/796,990

(22) Filed: Jun. 9, 2010

(51) Int. Cl. G06F 15/76; G06F 13/24; G06F 9/02; G06F 12/08

(52) U.S. Cl. 711/118; 712/37; 710/266; 711/E12.017; 712/E09.002

(57) ABSTRACT

An integrated circuit chip having plural processors with a shared field programmable gate array (FPGA) unit, a design structure thereof, and method for allocating the shared FPGA unit. A method includes storing a plurality of data that define a plurality of configurations of a field programmable gate array (FPGA), wherein the FPGA is arranged in the execution pipeline of at least one processor; selecting one of the plurality of data; and programming the FPGA based on the selected one of the plurality of data.

### FIELD OF THE INVENTION

The invention relates to an integrated circuit chip and, more particularly, to an integrated circuit chip having plural processors with a shared field programmable gate array (FPGA) unit, a design structure thereof, and method for allocating the shared FPGA unit.

### BACKGROUND

Computing machines are increasing the number of processors within a single system-on-chip (SOC). Multiprocessors, vector processors, and array processors all include plural processors on a single chip. At the same time, processing cost and the cost of mask production are increasing. In general, it is relatively expensive to design an integrated circuit chip and bring that chip to production. Due to such high cost, many product designers utilize one or more existing chips and adapt their product to the chip(s). For example, it is common to employ one or more processors cores integrated into a system-on-chip design, where the processor cores are fixed processors drawn from an existing library of available architectures.

However, fixed processors have a static instruction set and are not readily configurable for specific applications. On the other hand, users often want to tailor their design to specific needs, and potentially expand the function to targeted systems and system code. As a result, the use of fixed processors is becoming less attractive as applications and products become more specialized.

A field programmable gate array (FPGA) is a hardware portion of an integrated circuit that may be configured by the customer or designer after manufacturing. FPGAs use a 2-dimensional array of logic cells that are programmable, such that the FPGA functions as a custom integrated circuit (IC) that is modified by program code. Thus, a same FPGA can be alternately programmed to selectively perform the function of many different logic circuits. Typically, the programming of the FPGA is persistent until re-programmed at a later time. The persistent nature may be permanent (e.g, by blowing fuses in gates) or modifiable (by storing the programming code in a programmable memory).

Accordingly, there exists a need in the art to overcome the deficiencies and limitations described hereinabove.

### SUMMARY

In a first aspect of the invention, there is a method for controlling an integrated circuit. The method includes storing a plurality of data that define a plurality of configurations of a field programmable gate array (FPGA), wherein the FPGA is arranged in the execution pipeline of at least one processor; selecting one of the plurality of data; and programming the FPGA based on the selected one of the plurality of data

In another aspect of the invention, there is an integrated circuit. The integrated circuit includes at least two processors on a chip a field programmable gate array (FPGA) embedded in the execution pipelines of the at least two processors.

In yet another aspect of the invention, there is a system on chip, including a controller and a plurality of clusters. Each one of the plurality of clusters includes: a plurality of processors; a field programmable gate array (FPGA) arranged in the execution pipeline of the plurality of processors; and a control system configured structured and arranged to program the FPGA in one of a plurality of predefined configurations.

In another aspect of the invention there is a hardware description language (HDL) design structure encoded on a tangible machine-readable data storage medium, said HDL design structure comprising elements that when processed in a computer-aided design system generates a machine-executable representation of a multi-processor chip. The HDL design structure comprises: at least two processors on a chip; and a field programmable gate array (FPGA) embedded in the execution pipelines of the at least two processors.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIGS. 1-15 show aspects of an integrated circuit chip having plural processors with a shared field programmable gate array (FPGA) unit associated with aspects of the invention;

FIG. 16 is a flow diagram depicting steps of a method in accordance with aspects of the invention; and

FIG. 17 is a flow diagram of a design process used in semiconductor design, manufacture, and/or test.

### DETAILED DESCRIPTION

The invention relates to an integrated circuit chip and, more particularly, to an integrated circuit chip having plural processors with a shared field programmable gate array (FPGA) unit and method for allocating the shared FPGA unit. In accordance with aspects of the invention a shared FPGA unit is embedded in the execution pipeline of two or more processors. In embodiments, a control system selectively configures the input-output (I/O) mechanism of the FPGA unit and also the programmable logic of the FPGA unit. As described in greater detail herein, such changes in the configuration of the FPGA unit may be used to control the executable functions (e.g., logic) that the FPGA unit is performing for each processor, how much of the FPGA unit is allocated to each processor, and how signals are routed amongst the processors via the FPGA unit. In this manner, the resources of the shared FPGA unit may be dynamically shared over time and can be tuned to the algorithm being executed by an array of processors.

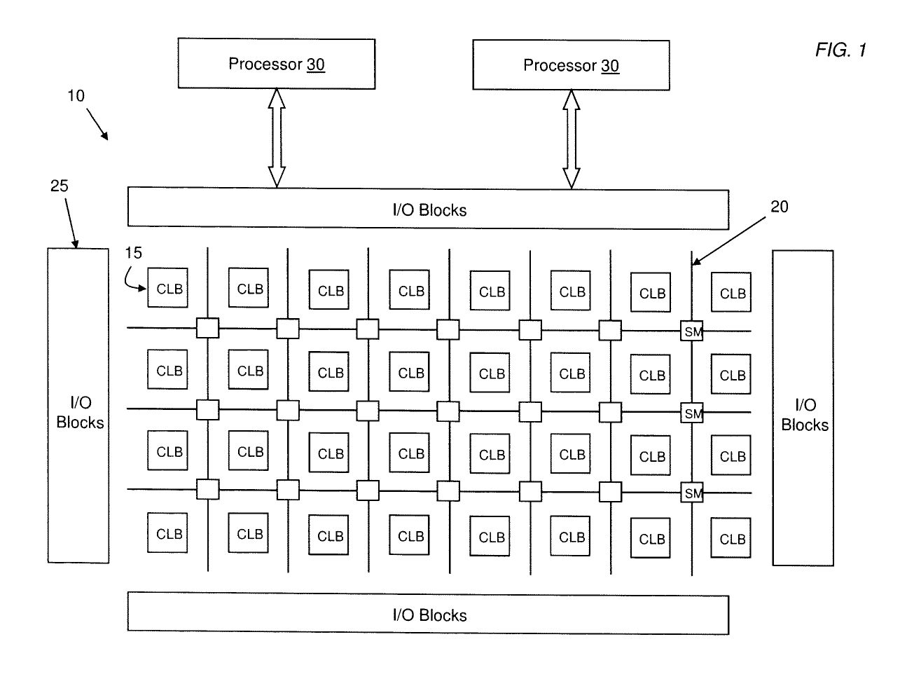

FIG. 1 shows an architecture of an FPGA unit that may be used in accordance with aspects of the invention. The FPGA unit 10 (also referred to herein and in the drawings as FPGA 10) comprises an array of configurable logic blocks (CLB) 15 and a switch matrix (SM) 20. Each CLB 15 is a programmable logic unit that may comprise hardware elements including, for example, SRAM cells, multiplexers, and registers, which can be programmed to perform combinational (or combinatorial) logic functions. The switch matrix 20 is an arrangement of programmable interconnects that connect the CLBs 15 together in any desired pattern. The switch matrix 20 can be programmed to provide the desired inputs to the CLBs 15, and also provide a path between the CLBs 15 and I/O blocks 25. The I/O blocks 25 comprise a multiport programmable I/O interface that physically connects the FPGA unit 10 to the processors 30. In embodiments, this fabric of the FPGA unit 10 is embedded in the execution pipeline of plural processors 30 in a system-on-chip (SOC). In accordance with aspects of the invention, different operational configurations of the FPGA unit 10 are pre-defined and stored in memory (e.g., cache memory) of the chip. Each configuration may define a particular programming for the CLBs 15, switch matrix 20, and I/O blocks 25.

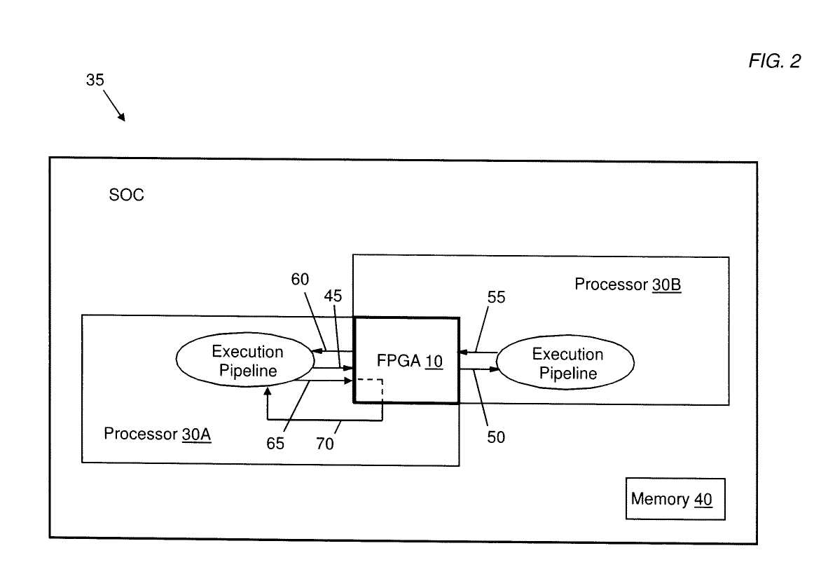

FIG. 2 shows a block diagram of a system-on-chip (SOC) 35 having two processors 30A and 30B, a shared FPGA unit 10, and on-chip memory 40 in accordance with aspects of the invention. In embodiments, the processors 30A and 30B are hardware-based microprocessors or processor cores. In accordance with aspects of the invention, and as depicted by arrow 45, processor 30A may drive data in its execution pipeline into the FPGA unit 10. The FPGA unit 10 may perform logic operations using the data. The FPGA unit 10 may output resultant data to processor 30B as depicted by arrow 50. The converse operation, e.g., from processor 30B to processor 30A is depicted by arrows 55 and 60. In embodiments, the FPGA unit 10 performs logic operations for the processor(s) without the need to perform read and write operations to the separate on-chip memory 40 or off-chip memory (not shown). In this manner, the FPGA unit 10 is said to be embedded in the execution pipelines of the processors 30A and 30B.

Additionally, as depicted by arrows 65 and 70, instead of being in the pipeline between two processors, the FPGA unit 10 may be used in the pipeline of a single processor, e.g., 30A. For example, processor 30A may drive data into the FPGA unit 10, the FPGA unit 10 may perform programmed logic operations using the data, and the resultant data may be output back to processor 30A.

Alternatively to performing logic functions between the processors, the FPGA unit 10 may be programmed to merely route data (e.g., signals) from the execution pipeline of one processor (e.g., 30A) to the execution pipeline of another processor (e.g., 30B). In this manner, the shared FPGA unit 10 may function as a router between processors.

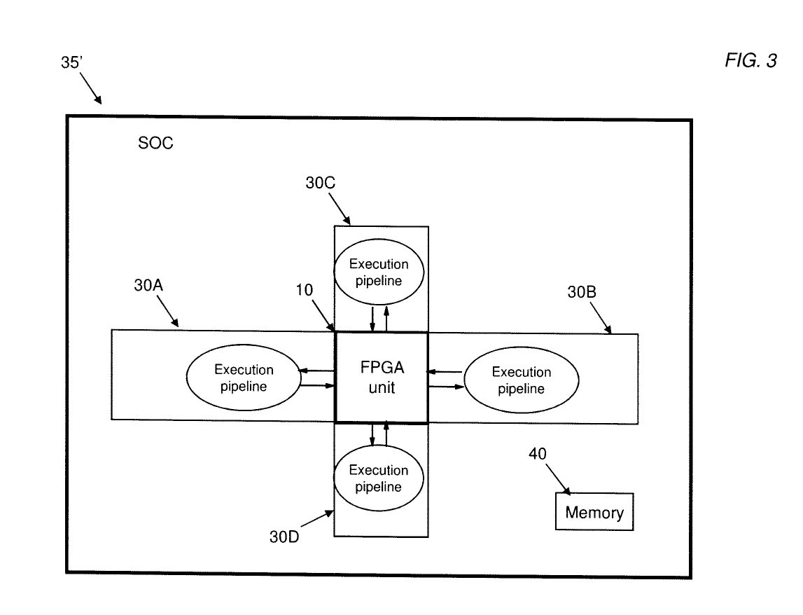

Although two processors are shown in FIG. 2, the invention is not limited to an FPGA unit 10 that is shared between only two processors. Instead, any number of processors (e.g., four, eight, etc.) may be used depending, for example, on the desired functionality and end use of the SOC. For example, FIG. 3 shows a block diagram of another system-on-chip (SOC) 35′ having four processors 30A-D, a shared FPGA unit 10, and on-chip memory 40 in accordance with aspects of the invention. The system depicted in FIG. 3 is similar to that of FIG. 2, except that the fabric of the shared FPGA unit 10 is embedded in the execution pipeline of four processors 30A-D. That is to say, the I/O blocks 25 of the FPGA unit 10 may be selectively connected to at least any one of the four processors 30A-D such that the FPGA unit 10 performs logic functions for and/or routes data between any one or more of the four processors 30A-D.

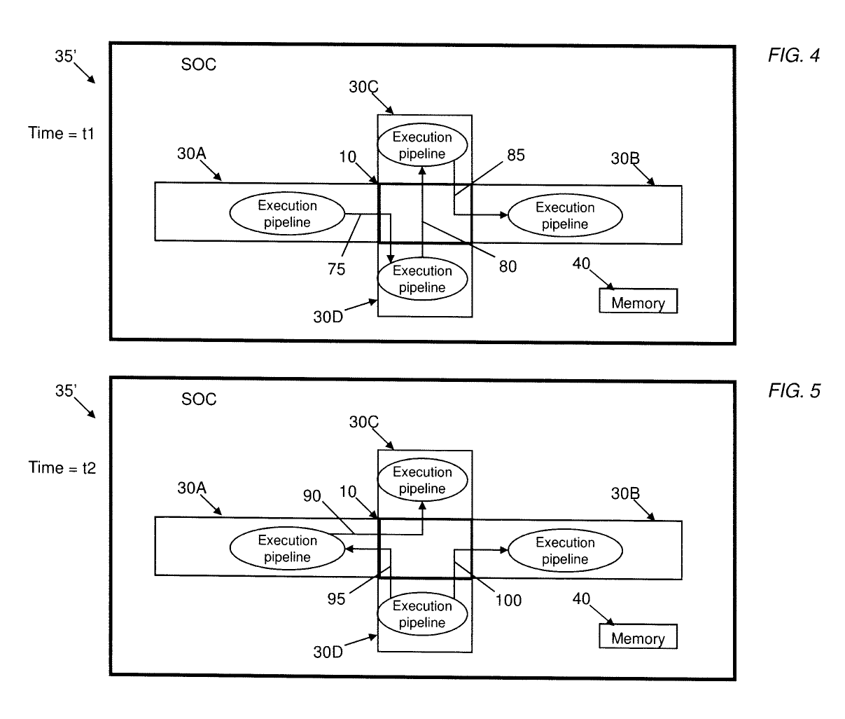

FIGS. 4 and 5 show two exemplary configurations of the SOC 35′ at two different points in time and illustrate a selectively configurable capability of the shared FPGA unit 10. Particularly, FIG. 4 shows the SOC 35′ at a first time, e.g., time t1. At time t1, the FPGA 10 is programmed to route data from the execution pipeline of processor 30A to processor 30D, as represented by arrow 75. Additionally at time t1, the FPGA 10 is programmed to route data from the execution pipeline of processor 30D to processor 30C, as represented by arrow 80. Also at time t1, the FPGA 10 is programmed to route data from the execution pipeline of processor 30C to processor 30B, as represented by arrow 85. As described herein, the FPGA unit 10 may be programmed to perform logic operations on the data being routed between the processors, or may be programmed to only route the data between the processors.

FIG. 5 shows the SOC 35′ at a second time, e.g., time t2, that is different from time t1. At time t2, the FPGA 10 is programmed to route data from the execution pipeline of processor 30A to processor 30C, as represented by arrow 90. Additionally at time t2, the FPGA 10 is programmed to route data from the execution pipeline of processor 30D to processor 30A, as represented by arrow 95. Also at time t2, the FPGA 10 is programmed to route data from the execution pipeline of processor 30D to processor 30B, as represented by arrow 100.

As depicted by FIGS. 4 and 5, the FPGA unit 10 may be configured to route signals in different directions amongst processors at different times. In embodiments, the changes in routing are achieved by programming, via the programmable I/O blocks 25, which I/O pins of the FPGA unit 10 are connected to I/O pins of the processors. Additionally and optionally, the FPGA unit 10 may be configured to perform logic functions on the data while routing the signals. In embodiments, the logic being performed by the FPGA unit 10 at any given time (e.g., t1, t2, etc.) is programmed via the CLBs 15 and switch matrix 20. As described in greater detail herein, the programming that defines the state of the FPGA unit 10 at any given time is created and stored in memory and then applied at different times to make the FPGA 10 behave in a pre-defined manner. In this manner, the act of programming the FPGA unit 10 defines the logic functions that the FPGA unit 10 performs and also defines the direction that signals are driven at the interface between the FPGA unit 10 and the processors (e.g., 30A-D).

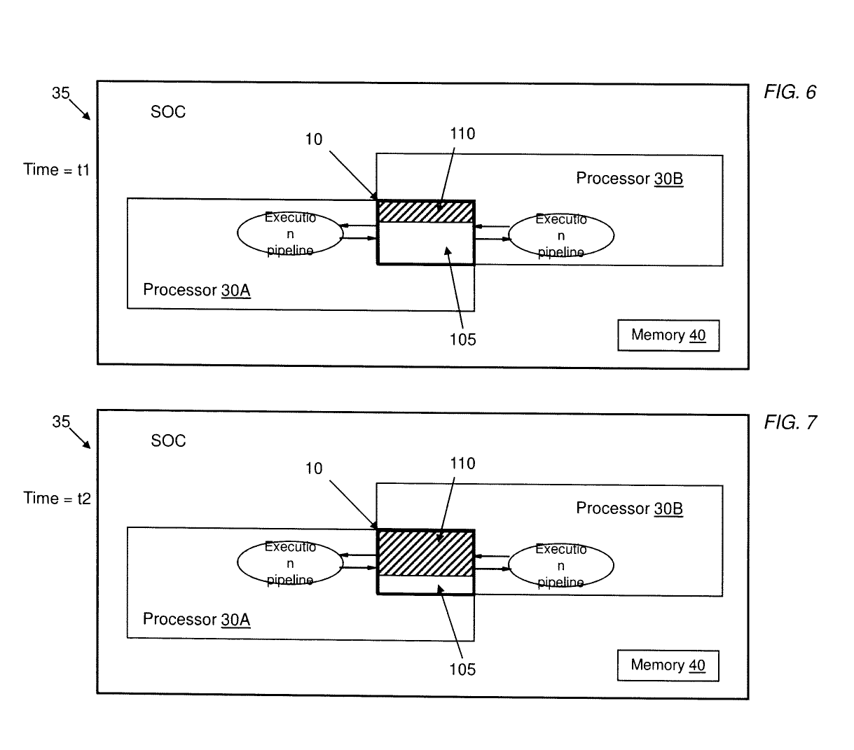

FIGS. 6 and 7 show two exemplary configurations of the SOC 35 at two different points in time and depict another aspect of the selectively configurable capability of the shared FPGA unit 10 in accordance with aspects of the invention. Particularly, FIG. 6 shows the SOC 35 at a first time, e.g., time t1, and FIG. 7 shows the FPGA unit at a second time, e.g., time t2, which is different from the first time. The times t1 and t2 described with respect to FIGS. 6 and 7 may be the same as or different from the times t1 and t2 described above with respect to FIGS. 4 and 5. In embodiments, the logic (e.g., execution) resources of the FPGA unit 10 may be partitioned and apportioned amongst the various processors (e.g., processors 30A and 30B). For example, dedicated logic slices of the FPGA unit 10 may be used exclusively by respective ones of the processors sharing the FPGA unit 10. In this manner, the logic resources of the FPGA unit 10 may be assigned to each processor based on the current need. As the needs of the processors change with time, the logic resources of the FPGA unit 10 may be re-partitioned and re-allocated amongst the processors.

For example, as depicted in FIG. 6, at time t1 the FPGA 10 is programmed to provide a first percentage 105 of its logic capability to processor 30A (e.g., in the execution pipeline of processor 30A) and a second percentage 110 of its logic capability to processor 30B (e.g., in the execution pipeline of processor 30B). Then at time t2, as depicted in FIG. 7, the values of the first percentage 105 and second percentage 110 are changed. For example, the value of the first percentage 105 may be decreased from time t1 to time t2, while the value of the second percentage 110 may be increased from time t1 to time t2. In this manner, implementations of the invention provide a shared FPGA unit 10 that has flexible partitions in the sense that the respective amount of execution capability provided by the FPGA unit 10 to the processors 30A and 30B may be adjusted at different points in time. For example, over time, an application may shift the primary bus fabric from the source to destination, and then be flipped or modified to a different portal connection to control application work flow. In embodiments, the bits can be any desired granularity (e.g., fine or coarse) depending on the application need.

Although FIGS. 4 and 5 and FIGS. 6 and 7 are described herein with respect to two different points in time, the invention is not limited to use with only two different time-based configurations for the FPGA unit 10. Instead, any number of configurations of the FPGA unit 10 may be pre-defined and stored in memory. Moreover, the routing and logic partitioning are not exclusive of one another. Instead, the teachings of FIGS. 4 and 5 may be used concurrently with the teachings of FIGS. 6 and 7 to provide a shared FPGA unit that is selectively configurable in both signal routing and logic partitioning. Moreover, in addition to partitioning the amount of logic resources of the FPGA unit, the programming may also be used to define precisely what type of logic functions are being performed by the FPGA unit 10 for each processor.

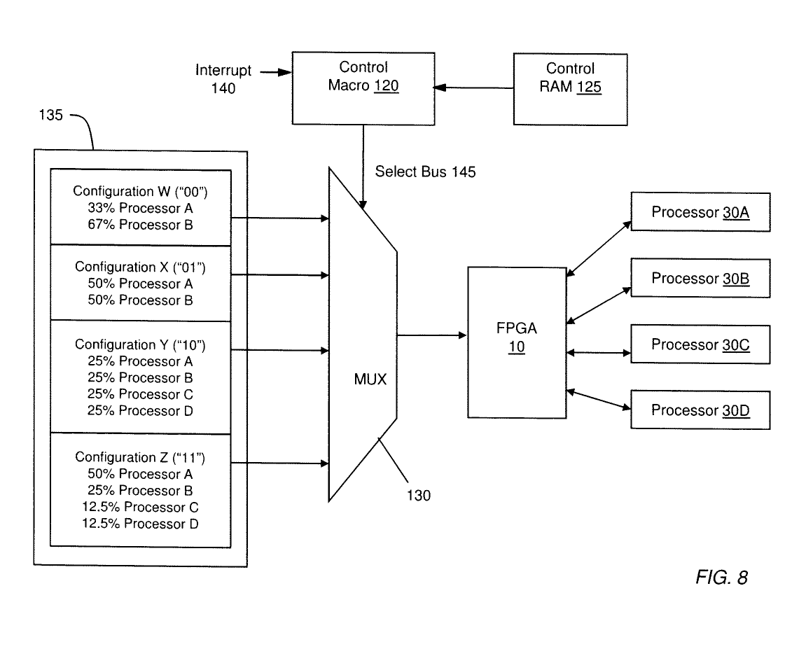

FIG. 8 shows a block diagram of a control system 115 for a shared FPGA unit 10 in accordance with aspects of the invention. In embodiments, the control system 115 includes a control macro 120, control RAM 125, multiplexer (MUX) 130, and cache memory 135. According to aspects of the invention, the cache memory 135 stores any desired number of programming instructions for pre-defined configurations of the FPGA unit 10. Four configurations W, X, Y, and Z are shown; however, the invention is not limited to this number of configurations, and any desired number may be used. In embodiments, each stored configuration may define at least one of: a signal routing scheme for the FPGA unit 10 (e.g., similar to that described with respect to FIGS. 4 and 5); a logic partition for the FPGA unit 10 (e.g., similar to that described with respect to FIGS. 6 and 7); and the particular logic functions to be performed by the FPGA unit for the processors. The stored configurations may be predefined and programmed into the cache memory based on the anticipated needs of the applications to be run on the processors sharing the FPGA unit 10. In embodiments, the control system 115 may be used with a tightly coupled cluster of processors in a system on chip, as described in greater detail below.

In accordance with aspects of the invention, the MUX 130 comprises a selector circuit that selects one of the configurations from the cache 135 and applies the selected configuration to the FPGA unit 10. In embodiments, the MUX 130 is controlled by the control macro 120 and control RAM 125. Particularly, when an interrupt 140 is applied to the control macro 120, the control macro 120 and control RAM 125 cause the MUX 130 to select one of the stored configurations and apply the selected configuration to the FPGA unit 10 in order to program the signal routing and/or logic partitioning of FPGA unit 10 in a predefined manner. For example, in embodiments, the interrupt 140 causes the control macro 120 and control RAM 125 to drive a select bus 145 that is connected to the MUX 130 and which causes the MUX 130 to load the next configuration into the FPGA unit 10. In this manner, implementations of the invention provide a system and method for dynamically sharing the FPGA resources that can over time be tuned to the algorithm being executed by an array of processors.

In embodiments, the control macro 120 includes a cached or paged structure of control port signals. The control system 115 may be structured and arranged, e.g., via programming, to load the next select bits for driving the select bus 145 into the control RAM 125 to choose a different configuration. The control system 115 may also be structured and arranged to load any number of desired configurations into the cache memory 135, switch from one configuration to another by loading a next configuration in to the FPGA unit, and restart the pipeline stages.

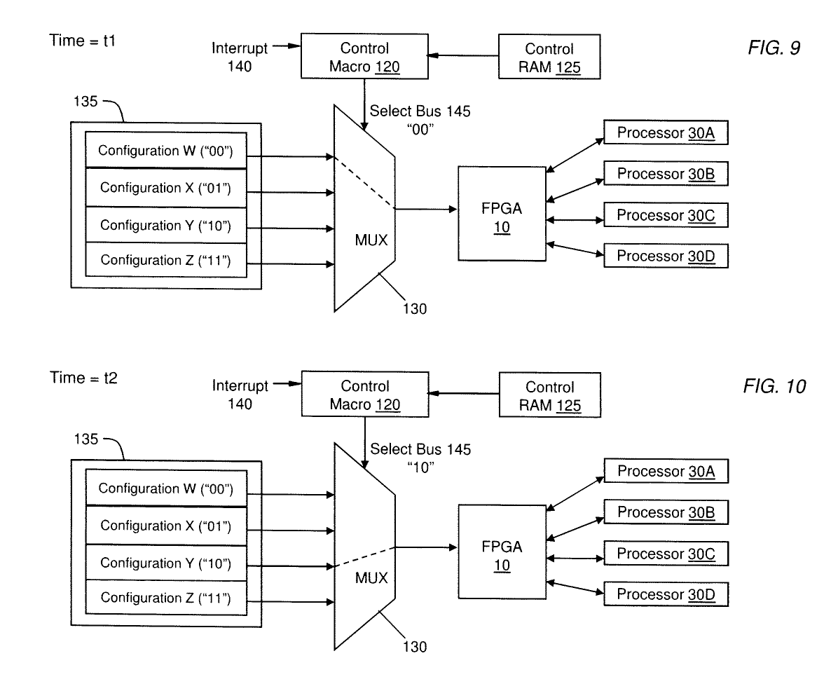

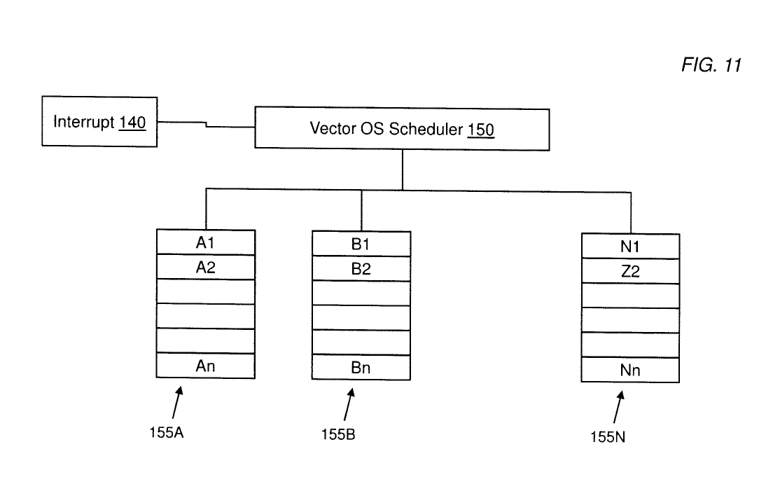

FIGS. 9 and 10 show two exemplary configurations of the control system 115 at two different points in time in accordance with aspects of the invention. Particularly, FIG. 9 shows the control system 115 at a first time, e.g., time t1, and FIG. 10 shows the control system 115 at a second time, e.g., time t2, which is different from the first time. The times t1 and t2 described with respect to FIGS. 9 and 10 may be the same as or different from the times t1 and t2 described above with respect to FIGS. 4-7. In embodiments, as depicted in FIG. 9, at first time t1 the control macro 120 receives an interrupt 140 and drives the select bus 145 with “00” which corresponds to configuration W. In response to the select bus 145 being “00” the MUX 130 applies configuration W to the FPGA unit 10. The programmable portions of the FPGA unit 10 are programmed according to configuration W, which in this example applies a partition that apportions one third of the FPGA logic to processors A and two thirds of the logic to processor B. The FPGA unit 10 operates in this configuration until a new configuration is loaded, as described with reference to FIG. 10.

Continuing the exemplary scenario from FIG. 9, FIG. 10 shows that, at second time t2, an interrupt 140 is applied to the control macro 120. This results in the control macro driving the select bus 145 with “10” which corresponds to configuration Y. In response to the select bus 145 being “10” the MUX 130 applies configuration Y to the FPGA unit 10. The programmable portions of the FPGA unit 10 are programmed according to configuration Y, which in this example applies a partition that apportions one quarter of the FPGA logic to each processors 30A-D. The FPGA unit 10 operates in this configuration until a new configuration is loaded, e.g., as a result of another subsequent interrupt. It is noted that the definitions of the configurations W-Z in FIGS. 8-10 are for illustrative purposes only, and the invention is not limited to these particular examples. Instead, any number of configurations defining any desired partitions, routing, and logic functions may be stored in the cache.

FIG. 11 shows a block diagram of an exemplary interrupt scheme that may be used with the control system 115 in accordance with aspects of the invention. In embodiments, the interrupt 140 may be driven by any suitable factor including, but not limited to, a predetermined time interrupt, a user action interrupt, and a branch conditional task interrupt. A predetermined time interrupt is an interrupt that is provided at a predefined time, e.g., during the processing of an application. A user action interrupt is an interrupt that is provided a result of a predefined action being taken by a user during processing. A branch conditional task interrupt is an interrupt that is provided as a result of a data dependency, e.g., when it is determined through analysis and/or testing of certain data that a particular condition is satisfied. FIG. 11 shows an operating system (OS) scheduler 150 and various sets of tasks 155A, 155B, . . . , 155N, that are to be run on different processors, e.g., processors 30A, 30B, . . . , 30N. In embodiments, the OS scheduler 150 can interrupt the processors and also drive an interrupt 140 to the control system 115 for changing the configuration of the FPGA unit 10.

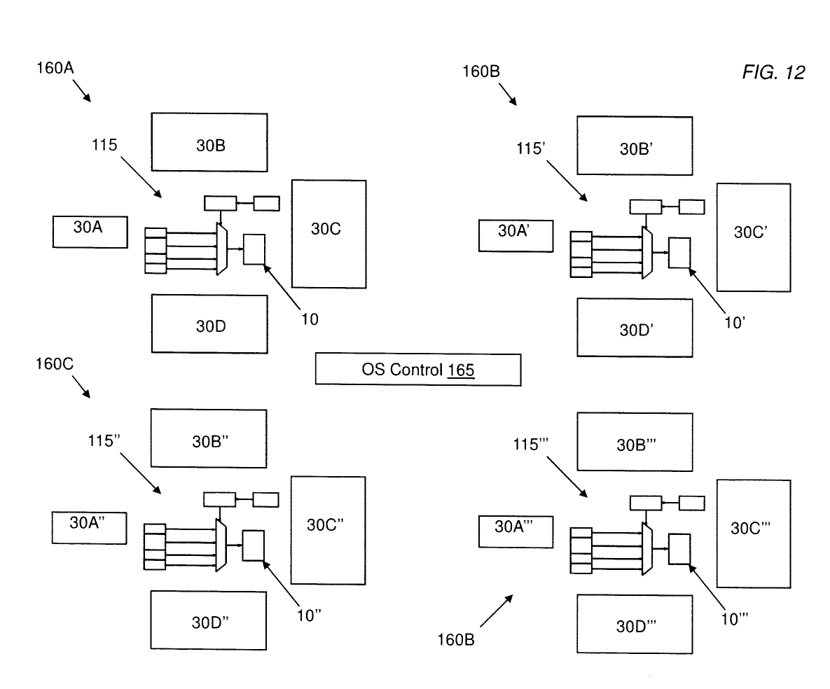

FIG. 12 depicts a chip comprising four clusters 160A-D in accordance with aspects of the invention. In embodiments, each cluster 160A-D includes four processors 30A-D, a shared FPGA unit 10, and a control system 115, as described herein. An OS control 165 schedules tasks to each of the clusters 160A-D. In embodiments, the components of each cluster are tightly coupled, which connotes that the FPGA unit 10 of one cluster (e.g., cluster 160A) is used only by the processors in that cluster and is not available to the processors of other clusters (e.g., clusters 160B-D). Although four clusters are shown each having four processors, the invention is not limited to this configuration. Instead, a chip having any number of clusters each having any number of processors may be used within the scope of the invention.

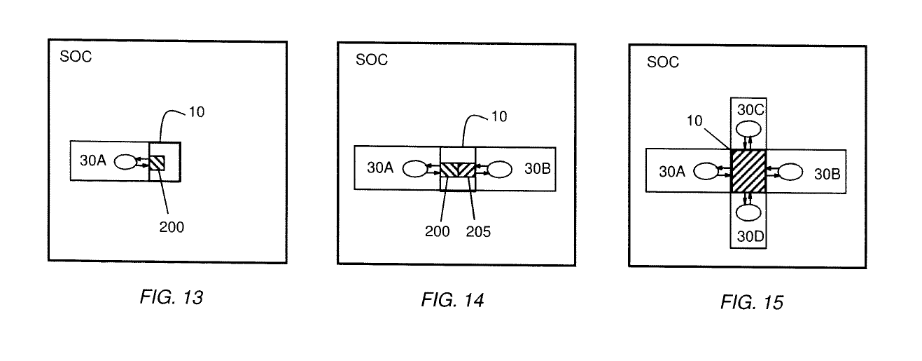

FIGS. 13-15 depict a partial re-configuration functionality of the shared FPGA unit 10 in accordance with aspects of the invention. Each configuration of the FPGA unit 10 requires an amount of storage space in the chip cache. Moreover, applying each configuration to the FPGA unit 10 takes an amount of time. However, it sometimes is the case that the entire amount of logic resources of the FPGA unit 10 are not needed at a particular time during processing, and instead that only a smaller subset of the logic resources of the FPGA unit 10 are needed. Accordingly, embodiments of the invention provide the ability to partially reconfigure the FPGA unit 10 by programming only the FPGA resources that need to be changed instead of programming the entirety of the FPGA resources. Partial programming is faster than programming the entire FPGA each time a configuration is changed. Partial programming also reduces the amount of memory used in the cache.

For example, FIG. 13 depicts a partition 200 of logic resources of an FPGA unit 10 that is programmed for processor 30A. The partition 200 represents less than the full amount of logic resources in the FPGA unit 10. FIG. 14 depicts that, later in time, processor 30B comes online and the FPGA unit 10 is reprogrammed to provide partition 205 to processor 30B. FIG. 15 depicts that, later in time, processors 30C and 30D come online and the FPGA unit 10 is reprogrammed to provide partition all of the logic resources amongst the processors. In embodiments, the speed of the system may be improved by programming (and reprogramming) only the FPGA resources that require change at any given time. The partial re-configuration described with respect to FIGS. 13-15 may be achieved using similar programming techniques as described with respect to FIGS. 4-10 by storing appropriate programming instructions in the cache (e.g., cache 135).

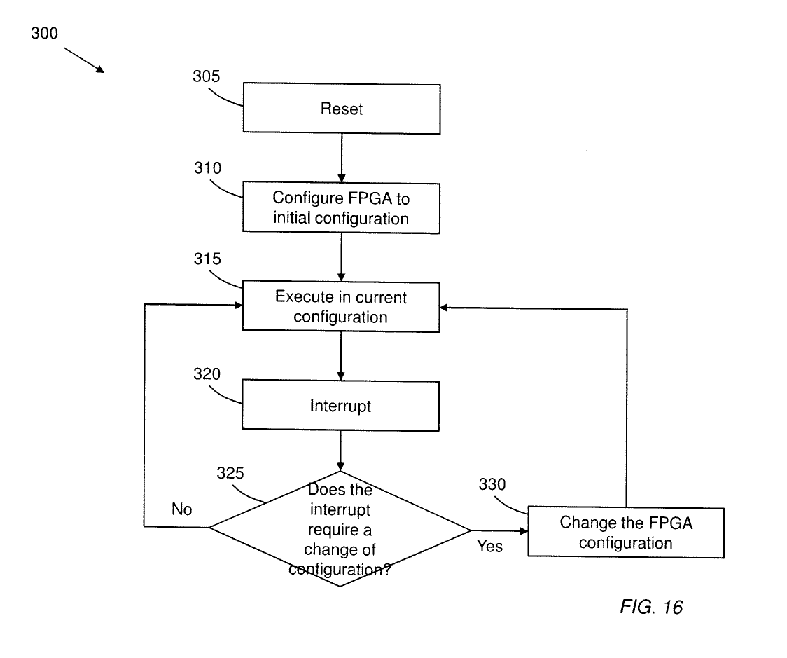

FIG. 16 shows a flow diagram of a control method in accordance with aspects of the invention. In embodiments, the control process may be used with any of the exemplary systems described herein, such as those depicted in FIGS. 1-15. At step 305, the operating system (including, for example, OS control 165 described herein) resets the system. At step 310, a configuration is selected and downloaded into the FPGA unit, which may be performed by the control system 115 in a manner similar to that described above with respect to FIGS. 8-11. At step 315, the processors and FPGA unit perform execution operations according to the application being run and also the current programmed configuration of the FPGA unit (e.g., signal routing, logic partitioning, and logic functions).

At step 320 an interrupt is generated, which may be performed by the operating system (including, for example, OS scheduler 150 described herein). At step 325, the operating system determines whether the configuration of the FPGA unit needs to be changed based upon the interrupt. If a change in configuration is not necessary based on this interrupt, then the process returns to step 315 where the processors and FPGA unit continue running the application. If a change in configuration is necessary, then at step 330 the control system (e.g., control system 115) reprograms the FPGA unit according to the interrupt (e.g., as described above with respect to FIGS. 8-11). This may include, for example, downloading the selected configuration bitstream into the FPGA unit for programming the I/O pins, logic, and routing used by each processor. Upon completion of the programming in step 330, the process returns to step 315 where the processors and FPGA unit continue running the application with the new configuration.

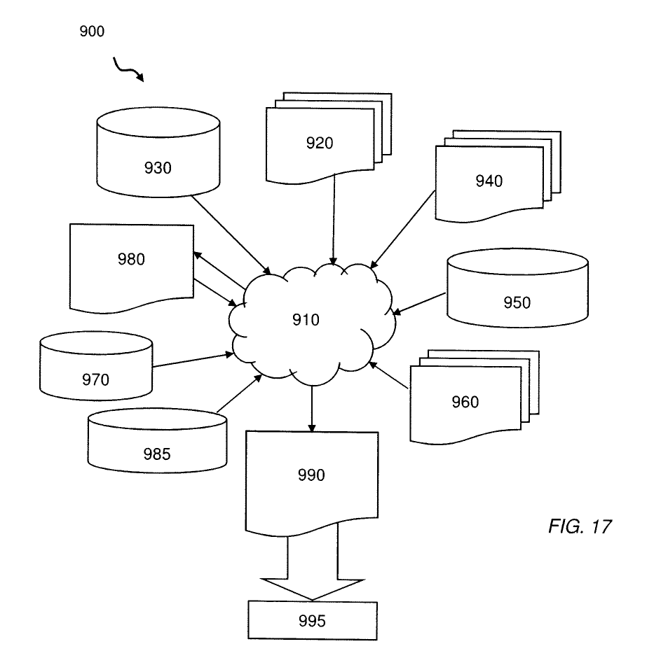

FIG. 17 is a flow diagram of a design process used in semiconductor design, manufacture, and/or test. FIG. 17 shows a block diagram of an exemplary design flow 900 used for example, in semiconductor IC logic design, simulation, test, layout, and manufacture. Design flow 900 includes processes, machines and/or mechanisms for processing design structures or devices to generate logically or otherwise functionally equivalent representations of the design structures and/or devices described above and shown in FIGS. 1-15. The design structures processed and/or generated by design flow 900 may be encoded on machine-readable transmission or storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g. e-beam writers), computers or equipment for simulating design structures, any apparatus used in the manufacturing or test process, or any machines for programming functionally equivalent representations of the design structures into any medium (e.g. a machine for programming a programmable gate array).

Design flow 900 may vary depending on the type of representation being designed. For example, a design flow 900 for building an application specific IC (ASIC) may differ from a design flow 900 for designing a standard component or from a design flow 900 for instantiating the design into a programmable array, for example a programmable gate array (PGA) or a field programmable gate array (FPGA) offered by Altera® Inc. or Xilinx® Inc.

FIG. 17 illustrates multiple such design structures including an input design structure 920 that is preferably processed by a design process 910. Design structure 920 may be a logical simulation design structure generated and processed by design process 910 to produce a logically equivalent functional representation of a hardware device. Design structure 920 may also or alternatively comprise data and/or program instructions that when processed by design process 910, generate a functional representation of the physical structure of a hardware device. Whether representing functional and/or structural design features, design structure 920 may be generated using electronic computer-aided design (ECAD) such as implemented by a core developer/designer. When encoded on a machine-readable data transmission, gate array, or storage medium, design structure 920 may be accessed and processed by one or more hardware and/or software modules within design process 910 to simulate or otherwise functionally represent an electronic component, circuit, electronic or logic module, apparatus, device, or system such as those shown in FIGS. 1-15. As such, design structure 920 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 910 preferably employs and incorporates hardware and/or software modules for synthesizing, translating, or otherwise processing a design/simulation functional equivalent of the components, circuits, devices, or logic structures shown in FIGS. 1-15 to generate a netlist 980 which may contain design structures such as design structure 920. Netlist 980 may comprise, for example, compiled or otherwise processed data structures representing a list of wires, discrete components, logic gates, control circuits, I/O devices, models, etc. that describes the connections to other elements and circuits in an integrated circuit design. Netlist 980 may be synthesized using an iterative process in which netlist 980 is resynthesized one or more times depending on design specifications and parameters for the device. As with other design structure types described herein, netlist 980 may be recorded on a machine-readable data storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, buffer space, or electrically or optically conductive devices and materials on which data packets may be transmitted and intermediately stored via the Internet, or other networking suitable means.

Design process 910 may include hardware and software modules for processing a variety of input data structure types including netlist 980. Such data structure types may reside, for example, within library elements 930 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 940, characterization data 950, verification data 960, design rules 970, and test data files 985 which may include input test patterns, output test results, and other testing information. Design process 910 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 910 without deviating from the scope and spirit of the invention. Design process 910 may also include modules for performing standard circuit design processes such as timing analysis, verification, design rule checking, place and route operations, etc.

Design process 910 employs and incorporates logic and physical design tools such as HDL compilers and simulation model build tools to process design structure 920 together with some or all of the depicted supporting data structures along with any additional mechanical design or data (if applicable), to generate a second design structure 990.

Design structure 990 resides on a storage medium or programmable gate array in a data format used for the exchange of data of mechanical devices and structures (e.g. information stored in a IGES, DXF, Parasolid XT, JT, DRG, or any other suitable format for storing or rendering such mechanical design structures). Similar to design structure 920, design structure 990 preferably comprises one or more files, data structures, or other computer-encoded data or instructions that reside on transmission or data storage media and that when processed by an ECAD system generate a logically or otherwise functionally equivalent form of one or more of the embodiments of the invention shown in FIGS. 1-15. In one embodiment, design structure 990 may comprise a compiled, executable HDL simulation model that functionally simulates the devices shown in FIGS. 1-15.

Design structure 990 may also employ a data format used for the exchange of layout data of integrated circuits and/or symbolic data format (e.g. information stored in a GDSII (GDS2), GL1, OASIS, map files, or any other suitable format for storing such design data structures). Design structure 990 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown in FIGS. 1-15. Design structure 990 may then proceed to a stage 995 where, for example, design structure 990: proceeds to tape-out, is released to manufacturing, is released to a mask house, is sent to another design house, is sent back to the customer, etc.

The method as described above is used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principals of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

What is claimed:

1. A method of controlling an integrated circuit, comprising:
storing a plurality of data that define a plurality of configurations of a field programmable gate array (FPGA), wherein the FPGA is arranged in the execution pipeline of at least one processor;
selecting one of the plurality of data; and
programming the FPGA based on the selected one of the plurality of data.

2. The method of claim 1, wherein the storing comprises storing the plurality of data in cache memory.

3. The method of claim 2, wherein the selecting comprises driving a bus that is connected to a multiplexer that is connected to the cache memory.

4. The method of claim 3, wherein the programming comprises downloading a configuration bitstream from the cache memory to the FPGA via the multiplexer.

5. The method of claim 1, further comprising receiving an interrupt, wherein the selecting and the programming are based on the interrupt.

6. The method of claim 1, wherein the integrated circuit comprises more than one processor, and further comprising arranging the FPGA in the execution pipeline of the more than one processor.

7. The method of claim 1, wherein the programming comprises programming the FPGA to provide at least one: of a first signal routing and a first logic resource partition.

8. The method of claim 7, further comprising:
selecting another one of the plurality of data; and
re-programming the FPGA based on the selected other one of the plurality of data, wherein the re-programming comprises programming the FPGA to provide at least one: of a second signal routing and a second logic resource partition.

9. An integrated circuit, comprising:
at least two processors on a chip; and
a field programmable gate array (FPGA) embedded in the execution pipelines of the at least two processors.

10. The integrated circuit of claim 9, wherein resources of the FPGA are shared between the at least two processors.

11. The integrated circuit of claim 9, wherein the FPGA is selectively configurable in at least two different configurations.

12. The integrated circuit of claim 11, wherein:
in a first one of the at least two configurations, the FPGA routes signals between the at least two processors according to a first predefined routing configuration;
in a second one of the at least two configurations, the FPGA routes signals between the at least two processors according to a second predefined routing configuration; and
the second predefined routing configuration is different than the first predefined routing configuration.

13. The integrated circuit of claim 11, wherein:
in a first one of the at least two configurations, logic resources of the FPGA are partitioned and apportioned amongst the at least two processors according to a first predefined partitioning configuration;
in a second one of the at least two configurations, logic resources of the FPGA are partitioned and apportioned amongst the at least two processors according to a second predefined partitioning configuration; and
the second predefined partitioning configuration is different than the first predefined partitioning configuration.

14. The integrated circuit of claim 11, further comprising a cache memory that stores data that defines the at least two configurations of the FPGA.

15. The integrated circuit of claim 14, further comprising:
a multiplexer connected between the cache memory and the FPGA; and
a control element connected the multiplexer.

16. The integrated circuit of claim 15, wherein the control element causes the multiplexer to download data that defines one of the at least two configurations into the FPGA.

17. The integrated circuit of claim 9, further comprising a control system that is structured and arranged to program only a subset of resources of the FPGA, wherein the subset of the resources is less than an entirety of the resources.

18. The integrated circuit of claim 17, wherein the control system is further structured and arranged to program a second subset of the resources at a different time than the programming the first subset.

19. A system on chip, comprising:
a controller; and
a plurality of clusters, wherein each one of the plurality of clusters comprises:
a plurality of processors;
a field programmable gate array (FPGA) arranged in the execution pipeline of the plurality of processors; and
a control system configured structured and arranged to program the FPGA in one of a plurality of predefined configurations.

20. The system on chip of claim 19, wherein respective components of each one of the plurality of clusters are tightly coupled.

21. A hardware description language (HDL) design structure encoded on a tangible machine-readable data storage medium, said HDL design structure comprising elements that when processed in a computer-aided design system generates a machine-executable representation of a multi-processor chip, wherein said HDL design structure comprises:
at least two processors on a chip; and
a field programmable gate array (FPGA) embedded in the execution pipelines of the at least two processors.

22. The design structure of claim 21, wherein the design structure comprises a netlist.

23. The design structure of claim 21, wherein the design structure resides on storage medium as a data format used for the exchange of layout data of integrated circuits.

24. The design structure of claim 21, wherein the design structure resides in a programmable gate array.
